(19) United States
(12) Patent Application Publication
(10) Pub. No.: US 2025/0267782 A1
(43) Pub. Date: Aug. 21, 2025

(54) Proton Torch with In-Situ Gas Generator Module

(71) Applicant: Arcflash Labs, Inc., Gold Canyon, AZ (US)

(72) Inventor: David Morgan Wirth, Gold Canyon, AZ (US)

(73) Assignee: Arcflash Labs, Inc., Gold Canyon, AZ (US)

(21) Appl. No.: 18/581,743

(22) Filed: Feb. 20, 2024

(51) Int. Cl. H05H 1/34; C25B 1/04; H05H 1/28

(52) U.S. Cl. CPC H05H 1/3423; C25B 1/04; H05H 1/28

(57) ABSTRACT

A system which facilitates the joining of metal or ceramic objects via heat in an oxygen-depleted atmosphere comprising: a plasma flame generator (torch), regulator, gas purifier, in-situ hydrogen generator, liquid pumps, battery, and electrical power supply. The electrical system is self-contained and is intended to provide equal or greater functionality to that of existing TIG/Plasma arc welders but in a portable form-factor free from reliance on expensive and cumbersome high pressure compressed gas bottles.

### BACKGROUND

Modern processes for the permanent joining of metal objects rely on the heating of such objects to the point of melting in order to fuse such objects into a single mechanically linked unit.

In the contemporary state of the art, this is typically accomplished through the use of Tungsten Inert Gas (TIG), Metal Inert Gas (MIG), or flux-coated stick welding. Other less frequently used methods in the trade include oxy-acetylene, oxy-propane, plasma welding, or laser welding. However, a commonality between all of these methods (with the limited exception of plasma welding) is that they require the use and transportation of large high pressure gas bottles. These are either a primary energy source for the welding process or necessary for an inert carrier gas to prevent oxidation during the high temperature joining process.

Some materials (such as ceramics) are difficult to melt and thus must be joined by other methods such as sintering, brazing, adhesive joining, or mechanical fastening. Such methods, while effective, may not be ideal for all jobs and may present other problems depending on the context wherein which they are applied.

As modern processes begin to rely more heavily upon composites and high temperature materials such as silicon nitride, zirconia, silicon carbide, tungsten carbide, titanium diboride and alumina—the methods of joining such materials tend to be either cost and safety prohibitive, expensive or thermodynamically prohibitive.

Furthermore, existing methods of material joining for more common materials such as steel, aluminum, and stainless steel have not found widespread usage with the ordinary man to the same extent as hand tools or portable torches (such as air-propane) due to the requirements of many of such processes for high wattage power sources, transportation and storage of inert gas cylinders, or specialized training (especially for arc-based processes such as TIG). Some methods (such as flux-core stick or wire welding or brazing) may offer a more accessible middle ground, but as above may not be advantageous or reliable or applicable certain jobs at hand.

Finally, those wishing to repair or join materials in a remote location must again transport heavy and dangerous gas cylinders, and/or provide a constant source of high current electrical power at the point of necessity. Some specialized vehicles are equipped to safely transport both, but such vehicles tend to be purpose-built and are not ideal for all situations.

In the contemporary market, several products have been recently released which attempt to some of the above mentioned problem. These include plasma welders, laser welders, and battery-powered portable stick welders. All of which tend to be specialized, limited in portability and high in cost.

The present invention draws upon an out-of-favor 1920's technique of atomic hydrogen welding in conjunction with modern high energy batteries (such as lithium ion), advanced semiconductors (such as integrated-gate bipolar transistors, IGBT), and recent advances in water-splitting electrolysis systems—to yield a unique and highly advantageous welding technology in the modern age.

Because of the very high temperatures associated with the Atomic Hydrogen Welding process, hydrogen embrittlement of the workpiece is avoided. Furthermore, because of the strongly reducing environment generated within the flame, materials when tend to form strong oxide layers (such as aluminum, titanium, molybdenum, etc.) otherwise difficult to weld via conventional methods, may be joined using a method of the current invention.

Challenges associated with the original atomic hydrogen welding systems of the 1920's mainly centered around the dangers of using highly pressurized hydrogen cylinders, and necessitated the use of large power transformers to supply high voltage, as well as great operator skill to start the arc.

An annular plasma torch electrode and modern high efficiency DC to AC power supply may also be employed by a such system herein referred to as a Self-Contained Atomic Hydrogen Welder (SCAHW) or a Proton Torch.

A proposed Proton Torch system is able to deliver an extremely high flame temperature (characteristic of atomic hydrogen) but within a safe, portable package, without the need to carry pressurized shielding or fuel gas cylinders.

A proposed Proton Torch system may be employed to create controllable and repeatable welding of a vast array of materials far greater than modern TIG or oxy-acetylene alone, in a form factor which frees an operator from being tethered to the power grid at all times.

Modern power supplies, lithium ion batteries and inductive spark generators alleviate many of the technical challenges, size and weight requirements associated with Atomic Hydrogen Welding in the past.

Furthermore, recent advances in the generation and storage of gaseous hydrogen including capillary-fed, zero-gap and proton-exchange membrane electrolysis cells, as well as reversible solid-state chemical hydrogen storage materials (such as amine boranes, microspheres, metal-organic frameworks, nanomaterials, zeolites, etc.) enable the generation and short-term storage of sufficient flow rates of hydrogen from a portable form factor.

### BRIEF DESCRIPTION OF THE DRAWINGS

FIG. 1 depicts an embodiment of a torch head showing an electrode (1), a gas lens (2), inner electrical collet (3), and gas entry point (4) where an alternating current is applied between the electrode and inner collet,

FIG. 2 depicts a more complete embodiment of a torch head consisting of two of the torch heads of FIG. 1, where each of the electrode (1) are connected to a pole of an alternating current source of electrical power, and at the point where the electrified electrodes (1) touch, a linear plasma arc (5) is struck, which when blown by the gas produced a high temperature linear plasma flame (6).

FIG. 3 depicts an alternate embodiment of a torch head showing a spacer collet (7) which separates electrical contacts with a potential difference with respect to each other while allowing the flow of gas through a set of flow vanes (8), directing said gas into the electrical arc. A gas lens (9) surrounds a pair of electrodes, with the outer electrode (10) shown in this figure.

FIG. 4 depicts a cutaway view of the torch head embodiment of FIG. 3, where a handle (11) is attached to the torch head through which gas passes and a gas entry point (12) allows said gas to flow into the torch and between a set of electrodes. Coolant flows from a coolant inlet (13) in order to prevent the heat from an annular plasma arc (14), and annular plasma flame (15) from damaging the inner electrode (16). The plasma flame (15) is positioned such that a workpiece 1 (17), and workpiece 2 (18), may be heated to a melting point at their point of joining, thus forming a weld line (19). The heated coolant then flows out of the coolant outlet (20) and is regenerated or disposed of.

FIG. 5 depicts a prototypical embodiment of a torch head of the current invention, featuring similar structures and functions as the alternate embodiments depicted in FIGS. 1-4, but with a different overall layout.

FIG. 6 depicts the prototypical embodiment of the torch head of FIG. 5 shown in cutaway view. In this view, the inner electrode (16) is shown nearly contacting the outer electrode (10), both of which are adjustable by means of threaded components.

FIG. 7 depicts a close-up detailed view of the spacer collet (7) positioned within the embodiment of FIG. 5-6, showing the radial gas flow vanes drilled through said collet.

FIG. 8 is a photograph of a prototype system of the embodiment depicted in FIGS. 5-7 with coolant flowing around the outer surface of the outer electrode, and gas flowing into the system between the electrodes and a small plasma flame can be seen at the tip of the torch head.

FIG. 9 shows a high level flow chart of an embodiment of the invention where interactions between various components of the invention are depicted. It depicts electrical connections and the flow of electrical energy from a battery into a plurality of other electrical components shown by arrows with single solid lines. It depicts the flow of liquids shown by arrows with double solid lines, and the flow of gases by arrows with single dashed lines.

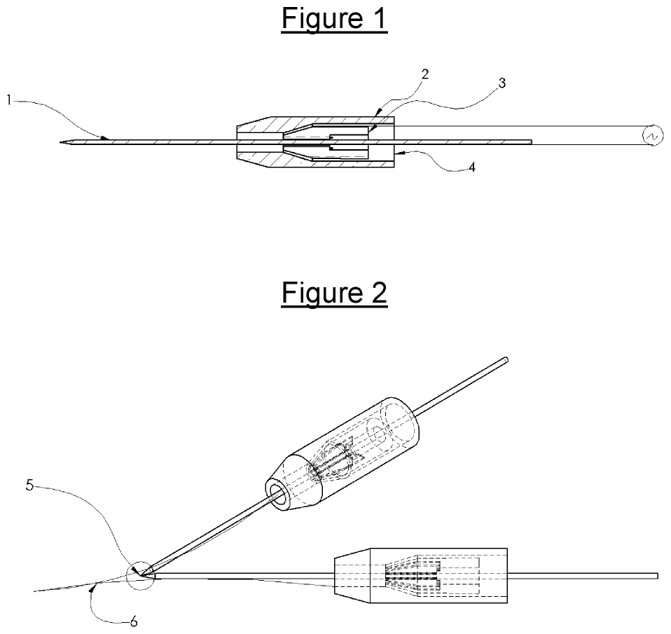

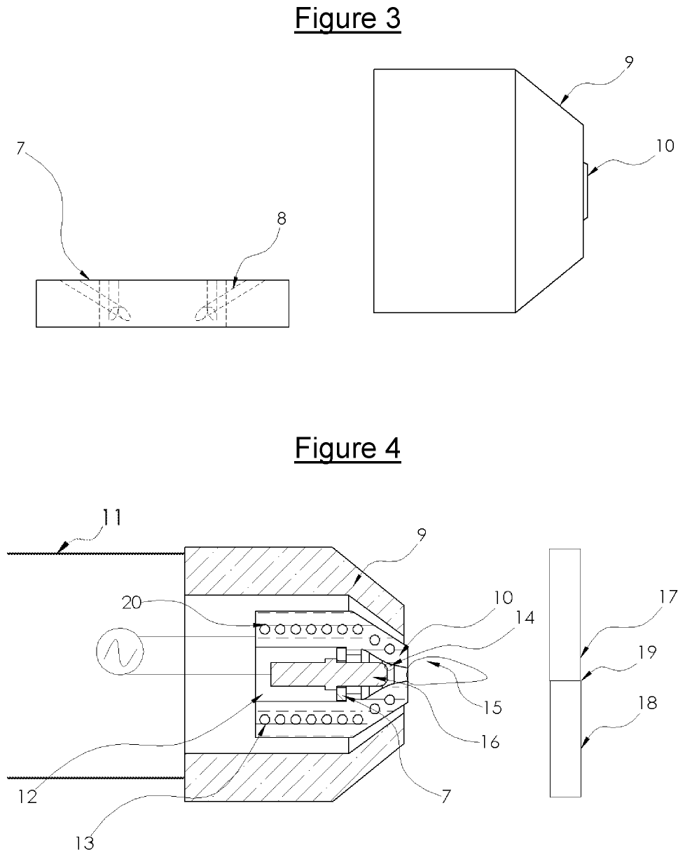

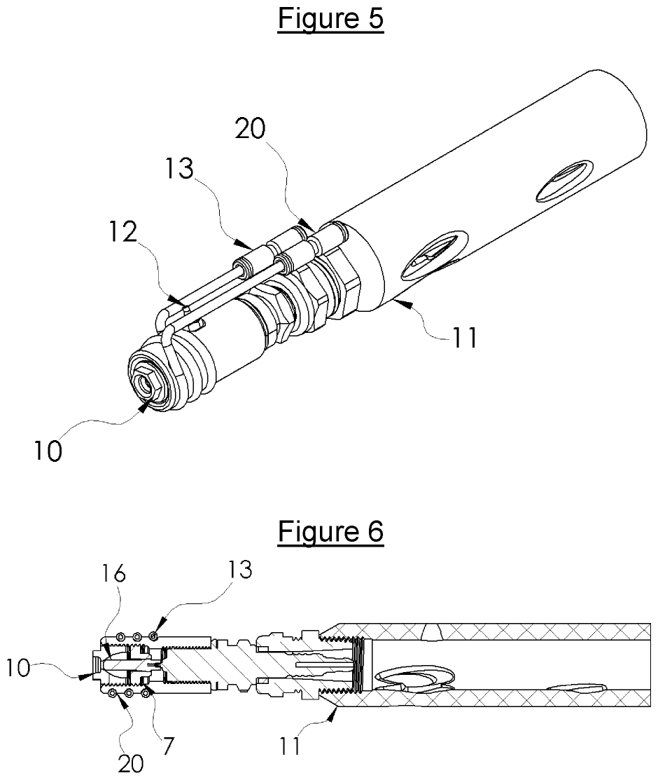

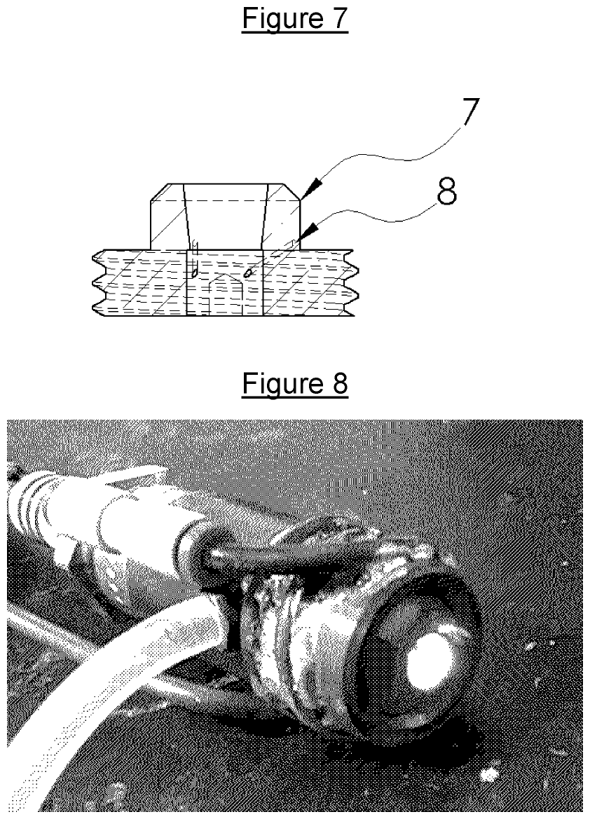

### DETAILED DESCRIPTION

Embodiments of the present invention offer an apparatus capable of producing a high heat in a localized area through the use of electrical current and a hydrogen gas stream to form a zone of singlet hydrogen/proton plasma. Such plasma is capable of rapidly delivering heat into a workpiece or multiple workpieces to be joined. A proton flame is capable of reaching temperatures of close to 4000 degrees C., which is sufficient to weld and fuse refractory materials previously only weldable using vacuum-arc or other exotic techniques.

Due to the intrinsic reducing characteristics of the singlet hydrogen flame, many previously difficult-to-weld materials can be joined with ease: including aluminum, titanium, tungsten, and molybdenum. Due to the extremely high flame temperature and the absence of a required electrical ground connection to the weldpiece, an even further compliment of materials are able to be joined, such as alumina, zirconia, titania, silicon nitride, tungsten carbide, silicon carbide, and titanium diboride, among other high temperature refractory materials such as ceramics and metal matrix composites.

The invention consists of a torch (21), a gas regulator (22), reservoir (23), gas filter and dryer/trap (24, 25), generation system (26), and electrical power control system (27, 28, 31, 32, 34). The electrical system is self-contained within the structural frame of the embodiment, and may consist of: batteries (31), inverters, switched mode power supplies (SMPS), rectifiers, and power conditioning components (27) intended to provide steady and controlled current to the torch. A microcontroller (34) may also be integrated into the system to provide a variety of improvements upon the basic apparatus and control the flow of gas via a solenoid valve (33), the flow of liquid to the gas generator (26) via a pump (29), or the flow of electrical power via the power conditioning system and power supply (27/28).

The torch (21) allows for an electrical arc to be generated between two electrodes in the presence of a flow of hydrogen or other suitable gas. Such a torch may be of annular design, linear, pyramidal, or any other suitable geometric configuration which allows for two or more electrodes to be brought in close proximity while immersed in a directed flow of hydrogen gas. Such a torch may also implement user controls for ease of one-handed operation. Such controls may include: hydrogen gas flow, hydrogen/oxygen gas switch, electrical voltage control, AC/DC power control, amperage control, arc gap distance control, pulse-width modulation, AC/DC bias control, AC frequency control, wire feed control/activation, coolant flow, etc. The torch may receive electrical power and signal, various pressurized gas lines, coolant lines, filler material wire, etc. The torch may also implement a form of a ‘dead-man's switch’ to cut off the flow of hydrogen and/or electricity if the operator loses contact with the torch head.

An embodiment of the current invention contains a sub-system which generates gas in-situ (26) on demand from one or more liquids stored within a reservoir (30) of the device. This sub-system may be a proton exchange membrane (PEM)-based electrolysis cell, alkaline hydrogen generator, compact thermolysis system, regenerative hydrogen adsorption/absorption or chemical storage system, metal hydride, compressed hydrogen gas container, several chemicals which when mixed produce hydrogen, or any other method of storing, generating or releasing hydrogen on demand.

In an embodiment gas generation system (26) may produce hydrogen gas on demand. In one embodiment of the invention, hydrogen gas is produced via catalyzed water splitting within an electrolysis system. In an embodiment, the electrolysis system is comprised of stainless steel plates clamped such that their faces are parallel with one another, and electrically such that one positive plate is flanked on either side by many “neutral plates” and capped at the ends by a negative plate at each end. Such a positive electrode plate is raised to an electrical potential proportional to the number of “neutral plates” in between the positive and negative electrodes. Such plates may be hydraulically partitioned from each other by means of a semi-porous membrane (such as high-thread count cotton, or polyester, or rip-stop nylon [polyamide] fabric). And where the gases produced on opposite sides of each partition are directed into separate gas streams (one for hydrogen and one for oxygen). The plates and membranes in such a system may be hydraulically sealed using gaskets made from an alkaline-resistant material (such as Silicone, Viton, EPDM, Butyl, etc.) In one embodiment of the present invention, the gas generator system may be maintained at a low pressure (under 200 psi) to reduce weight, reduce cost, increase safety of the process, and to prevent gas leakage from seals. In an embodiment, the gas generator is a commercially procured “Hydrobullet R06 1200 cc” polyamide membrane-based separator system. In an alternate embodiment, the gas generator is a Hysata capillary/diffusion-based water splitting system of similar type to that described in WIPO PCT WO2023/193057.

In alternate embodiments, such water splitting may be performed in an alkaline electrolysis cell in either the parallel or series configuration, or in a hydraulically separated water splitting cell such as a Proton-Exchange Membrane based cell using a separator material such as Nafion or Fumasep membrane among others. Or in an Anion-Exchange Membrane based cell using a separator membrane such as benzimidazolium, polyarylene, or Fumasep-based membranes, among others. Or in a Bipolar Membrane based cell using a Fumasep FBM based membrane among others. In such an embodiment the working fluid in the hydgogen generator may consist of di-ionized or distilled water to which may be added primary, secondary or tertiary alcohols, carbon, urea, glycerol, amine, alkaline, or acid-based additives to enhance conductivity and ion-transfer characteristics. Use of such a proton or anion or bipolar membrane allows for much higher pressures to be built up within the system, which may be advantageous to the production of gas within the gas generation system. However, in such a system, a pressure relief valve would be necessitated to prevent the uncontrolled pressurization of gas.

In an alternate embodiment, the gas generation system (26) may produce hydrogen on demand via separation from other gases via a membrane-less cell directed into a Pressure Swing Adsorbtion system. In yet another alternate embodiment, the gas generation system may produce hydrogen on demand via auto-catalytic chemical hydrogen production (such as the mixing of aluminum with hydrochloric acid or the addition of water to sodium hydroxide and ferrosilicon or of water to a gallium/aluminum amalgam), or by means of a photocatalytic process, or by means of a biological process (such as an algae bioreactor or anaerobic bacteria digester), or by means of a high temperature sulfur-iodine or copper-chlorine cycle, or by means of decomposition of a weakly bound metal hydride (such as LiAlH₄, among others), or via a compact thermolysis system, regenerative hydrogen adsorption/absorption or chemical storage system, other metal hydride, compressed hydrogen gas container, or by another means of generating hydrogen gas on demand in a safe and controllable fashion.

Said hydrogen gas travels to a torch-head (21) where it passes between two electrified contacts (10), (16), and an electrical arc and forms. The high heat of the arc and electrical power delivered to the torch generate heat which is carried away from the torch by a flame of atomic hydrogen (15). Such a flame may be used to impart great heat upon one or more workpiece(s) in order to create localized effects such as fusion, bending, annealing, forming, tempering, etc.

In an embodiment of the present invention, another gas such as oxygen, nitrogen, helium, argon or air may be fed into the torch in order to effect a plasma cutting rather than a welding environment. In an embodiment, the oxygen gas may be generated by the same gas generator (26), and may be recombined with or in place of the hydrogen, and supplied to the torch in order to increase the flame temperature or energy delivery, or to facilitate ease of ignition, or produce an oxidizing environment at the torch (21).

In an embodiment, the gas(es) may be stored in an interim reservoir (23) after passing through a set of liquid traps (25), filters (24) and/or other methods for drying or conditioning the gas prior to entering the torch (21).

In an embodiment, the gas is switched on or off using a solenoid valve (33) or other means for electrically controlling the flow of gas through the torch (21).

In an embodiment, a microcontroller(s) (34) may control a source of high voltage in order to ignite, re-ignite or enhance the stability of the energized flame and enable ease of use for the operator. In an embodiment, the generation of high voltage may occur within the power supply (28), power conditioning (27) or an element of the torch (21) itself.

In an embodiment of the present invention, an electronic microcontroller (such as an ATMega 328p) may be employed in such a way as to control the torch, electrical arc, gas generation, wire feeding, or other features of the apparatus. Such electrical features will be implemented in such a way as to ease the workload on the operator and facilitate ease of use of the apparatus for the purpose of welding and/or cutting.

In an embodiment, electrical power between 20 volts and 10,000 volts is supplied to the electrodes via a power supply (28) and a power conditioning unit (27). In an embodiment, the power conditioning unit (27) is a DC to AC inverter. In an embodiment, the power conditioning unit (27) is a resonant DC to DC or DC to AC switched mode power supply. In an embodiment, the power supply (28) controls the flow of DC current from the battery (31), to the power conditioning unit (27), the microcontroller (34), the pump (29), and the gas generator or gas control system (26)/(33).

In an embodiment, the power conditioning unit is an Arcflash Labs Clamped Quasi-Resonant DC-DC power supply as described in U.S. Pat. No. 10,811,995.

In an embodiment, the power supply (28) may be configured to accept DC current from the battery (31), or may feature an integrated switched-mode power supply (SMPS) to accept AC power as well without the use of an external AC adapter (32). In an embodiment, the SMPS is detachable and contained within the adapter (32).

In an embodiment, the electrical power conditioning system (27) comprises a number of electrical components intended to supply variable voltage and/or variable current electrical power to the torch for the purpose of sustaining the plasma flame (15). A short high voltage pulse may be generated for the purpose of arc starting, followed by lower voltage, high current AC or DC power supplied from a built-in battery pack, inverter, AC adapter, switched mode power supply, buck converter, boost converter, buck-boost converter, SEPIC converter, transformer, capacitors, inductors, or rectifiers or any combination thereof. The electrical power conditioning system may include features which allow for the adjustment of frequency, voltage, current, AC/DC balance, power source, etc. Such power conditioning system may interface with an electrical microcontroller and/or control inputs from the operator.

The switched mode power supply within the power conditioning system (27) may consist of any type of high current, high voltage capable power supply. It may employ an adjustable linear voltage controller, buck, boost or single-ended primary-inductor converter (SEPIC) converter, or any adjustable voltage power supply of sufficient current capacity to supply all elements of the system including the torch, gas generator system, pumps, solenoids, heaters, switches, microcontrollers, etc. The switched mode power supply may also employ a source controller element which would allow an operator to use an AC power connection for supplying power to the torch, or to select battery power. The switched mode power supply may also feature a secondary feature which recharges the battery pack when connected to AC power.

In an embodiment of the invention, an H-bridge system may be added to the power conditioning system (27) in order to vary the polarity of the torch electrodes, facilitate the connection of the workpiece into the electrical circuit, vary the frequency, polarity or duty cycle of the electrical energy passing through the torch and/or workpiece. In an alternate embodiment, a ground clamp may be added to the workpiece and current switched from between the torch electrodes (10)/(16) and a ground.

In an embodiment of the present invention, such an apparatus may use batteries to supply power for both the gas generator (26) and welding torch (21), allowing such a system to be used independently from centralized power grids.

In another embodiment of the invention, alternating current may be used as the power source instead of the battery pack (31).

In an embodiment of the present invention, power may be supplied by a battery pack (31) to enable portability and versatility of the system. Such a battery pack may consist of many cells wired in series, parallel, or both series and parallel. In one embodiment of the present invention, the cells may be of the lithium-ion 21700 type and may be connected together in such a way as to supply 120V directly to the power conditioning system which passes the current through an inverter and the output of such inverter is connected to the torch. In one embodiment of the present invention, the battery may consist of multiple Turnigy Graphene 1300 mAh 6S Lithium Polymer battery packs wired in series.

In an alternate embodiment, the battery pack cells may be of the lithium-ion 18650 or 19670 or 25500 type. In another embodiment, the cells may be of any suitable package to supply the desired current or voltage of pack size requirements of a given system. In another embodiment, the cells may be of the lithium-polymer chemistry in any variety of sizes and wired in any number of configurations. In yet another embodiment, the cells may be of the lithium ferrous phosphate, lithium air, aluminum air, zinc air, silver oxide, silver zinc, glass battery, vanadium flow, or any other battery chemistry which has a high specific energy per unit mass. Electrical double layer capacitors (aka. Supercapacitors), hybrid capacitors, electrolytic or other fast-discharge electrostatic based energy storage medium may also be integrated into the system in order to facilitate energy storage and/or fast or controlled discharge of stored energy. In an embodiment, the battery pack (31) is one of, or a combination of battery types known to those of ordinary skill in the state of the art.

In an alternate embodiment, the battery pack cells may be connected together in any way as to supply a voltage between 2-500V and a current of up to 600 A either directly to the torch, or to the power conditioning system, or through a variable or fixed frequency inverter. In a preferred embodiment, the battery output voltage is between 20 and 100 volts. In an embodiment, the battery is removable, interchangeable and/or replaceable.

In an embodiment, liquid from the liquid reservoir (30) is also pumped through the torch (21) as coolant. In an alternate embodiment, a separate pump is controlled by the microcontroller (34) to supply coolant to the torch (21). In an alternate embodiment, the torch is air cooled or gas cooled or cooled using one of a number of other alternate embodiments readily apparent to those of ordinary skill in the state of the art.

In another embodiment of the invention, a wire or rod or stick of material may be passed between or near the proton flame in order to provide filler material for the joining of two or more workpieces.

In an embodiment, a gas regulator(s) (22) allows for a user or the microcontroller (34) to manually or automatically adjust to gas pressure and/or flow rate to the torch (21). Such a regulator may also include a molecular sieve, drying, or filtering material or these may be attached separately within the gas stream via a set of traps (25) and/or filters (24) to allow for the removal of liquid or water vapor or other impurities from gas lines for the purpose of ensuring pure hydrogen (or other gas) is supplied to the torch head. Said traps/filters may employ a molecular sieve or chemical adsorbent/absorbant material, or fibrous filter such as cotton, fiberglass, cellulose, nylon, or microporous polycarbonate, or may utilize centrifugal separation or one among many methods known to those of ordinary skill to purify a stream of gas.

Regulator(s) (22) may adjust the flow of hydrogen, oxygen, air, or any other gas mixture within the apparatus, and may be placed in any position or various positions along the gas line(s) in conjunction with other pneumatic or hydraulic fixtures such as valves, orifices, solenoid valves, etc.

In one embodiment of the present invention, a wire feeding mechanism may be included next to or concentrically within the plasma flame and/or torch head. Such a mechanism may be fed through the torch using sensors and inputs from the microcontroller, or as a bolt-on system, or manually fed by the operator (such as in a MIG system). In an alternate embodiment of the invention, a rod feeding mechanism may be used to provide filler material. Such a rod may be fed into the plasma flame through or next to the torch, automatically (using a stepper motor) or manually (such as in a TIG system).

In an embodiment, the torch is water or gas cooled with channels flowing through one or both of the electrodes (10)/(16) or through a gas lens (9), or may be air cooled or cooled passively by the flowing hydrogen or other gas.

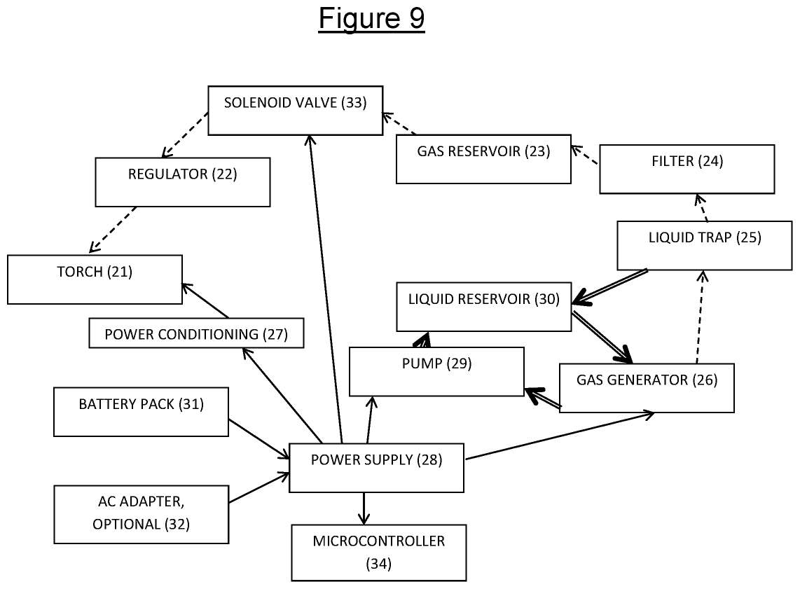

Finally, it is important to note that the block diagram of FIG. 9 represents one notional form which the present invention may take, but other forms or arrangements of the mentioned components or the inclusion of other components, or the elimination of some of the stated components may be possible while still effecting a system which accomplishes the stated function of the present invention which is: the generation of an atomic hydrogen flame without the need to store high pressure hydrogen or connect to an external source of electrical power during operation.

In this document and attached documents, the use of any and all examples, or exemplary language provided is intended merely to better illuminate one or more embodiments and does not pose a limitation on the scope of any claimed subject matter unless otherwise stated. No language herein should be construed as indicated any non-claimed subject matter as essential to the practice of the claimed subject matter.

The use of the terms “a”, “an”, “said”, “the”, and/or similar referents in the context of describing various embodiments (especially in the context of the following claims) are to be construed to cover both the singular and the plural, unless otherwise indicated herein or clearly contradicted by context.

When any phrase (i.e. one or more words) appearing in a claim is followed by a drawing element number, that drawing element number is exemplary and non-limited on claim scope.

Within this document, and during prosecution of any patent application related hereto, any reference to any claimed subject matter is intended to reference the precise language of the then-pending claimed subject matter at that particular point in time only.

Every portion (e.g. title, field, background, summary, description, abstract, drawing, figure, etc.) of this document, other than the claims themselves and any provided definitions is to be regarded as illustrative in nature and not as restrictive. The scope of the subject matter protected by any claim of any patent that issues based on this document is defined and limited only by the precise language of that claim (and all legal equivalents thereof) and any provided definition of any phrase used in that claim, as informed by the context of this document.

1. An apparatus for generating an oxygen-depleted plasma flame; wherein said oxygen-depleted plasma flame contains hydrogen, and the means for generating said hydrogen within the apparatus is not a pressure vessel.

2. The apparatus of claim 1, wherein said apparatus which weighs less than 100 lbs.

3. The apparatus of claim 1, wherein the hydrogen is generated electrochemically within the apparatus via an electro-disassociation of water or other hydrogen-containing fluid.

4. The apparatus of claim 1, wherein the apparatus is provided electrical power by a portable battery pack mechanically constrained to said hydrogen source and other components, such that the entire functional apparatus can be transported as one unit by an operator without the need for an external connection.

5. The apparatus of claim 1, wherein said hydrogen is supplied to a set of two or more electrodes, between which an electrical current is passed through a gas stream containing said hydrogen.

6. The apparatus of claim 5, wherein the electrodes are placed concentrically with respect to one another.

7. The apparatus of claim 5, wherein a flow of hydrogen is forced between or parallel to the surface of the set of electrodes such as to create a jet of hydrogen plasma flowing away from a hand-held torch unit.

8. The apparatus of claim 5, wherein an operator may vary the phase, voltage, amperage, frequency or duty cycle of the electrical current passed between the set of electrodes.

9. The apparatus of claim 5, wherein the amperage may be adjusted from 5-600 A.

10. The apparatus of claim 7, wherein the operator may vary the rate of the hydrogen flow between the electrodes.

11. The apparatus of claim 7, wherein the flow of hydrogen gas is also used to cool the electrodes.

12. The apparatus of claim 7, wherein the electrodes are cooled by a liquid or gas flowing within or around them.

13. The apparatus of claim 7, wherein the electrodes are circular, tubular, square, triangular, or polygonal in cross section.

14. The apparatus of claim 7, wherein the electrodes are comprised chiefly of tungsten or copper, or an alloy which contains tungsten or copper.

15. A system, configured to generate and supply a pure elemental gas to an electrified torch comprising:
a) A gas generator comprising a reaction chamber which is maintained at a pressure under 200 pounds per square inch; and,
b) A flow of fluid through said reaction chamber which may be facilitated by a pump or multiple pumps; and,
c) A valves or set of valves which may switch between gas streams generated by the reaction chamber, or toggle gas flow to the torch; and,
d) A control system which may direct the amount of gas generated.

16. The system of claim 15, wherein said reaction chamber comprises an arrangement of porous or electroporous membranes in fluid contact with metal electrodes, supplied with a DC electrical bias, and connected in such a way as to separate pure gaseous products from liquid feedstock.

17. The system of claim 15, wherein the reaction chamber is supplied with electrical power from the same principal power source as the torch.

18. The system of claim 15, wherein the reaction chamber is a chemical, electro-chemical, thermal, electro-thermal, or electro-thermal-chemical type reaction chamber which generates hydrogen and oxygen from a fluid containing water.

19. The system of claim 15, wherein the gaseous output of the reaction chamber is governed by a logical, electrical, or mechanical control system mounted in close proximity to or within the system.

20. The system of claim 15, wherein a pump circulates liquid through both the gas generator and torch (for cooling) either in parallel, series, or in separate loops.
